(19) United States
(12) Patent Application Publication
(10) Pub. No.: US 2025/0002723 A1
(43) Pub. Date: Jan. 2, 2025

(54) PROCESS FOR PRODUCING A BINDER FOR AN ASPHALT COMPOSITION

(71) Applicant: Stora Enso OYJ, Helsinki (FI)

(72) Inventors: Heikki Lotti, Stockholm (SE); Jesper Ekström, Johanneshov (SE); Dimitri Areskogh, Bromma (SE)

(73) Assignee: Stora Enso OYJ, Helsinki (FI)

(21) Appl. No.: 18/701,012

(22) PCT Filed: Nov. 8, 2022
(86) PCT No.: PCT/IB2022/060732

§ 371 Date: Apr. 12, 2024

(30) Foreign Application Priority Data
Nov. 11, 2021 (SE) 2151384-1
Jul. 12, 2022 (SE) 2230237-6

(51) Int. Cl. C08L 95/00; C08H 7/00; C08K 9/08

(52) U.S. Cl. CPC C08L 95/00; C08H 6/00; C08K 9/08; C08L 2555/52; C08L 2555/82

(57) ABSTRACT

The present invention is directed to a process for preparing a binder for an asphalt composition. The binder comprises lignin, a renewable and bio-based material, which replaces part of the fossil-based bitumen.

### FIELD OF THE INVENTION

The present invention is directed to a process for preparing a binder for an asphalt composition. The binder comprises lignin, a renewable and bio-based material, which replaces part of the fossil-based bitumen.

### BACKGROUND

Asphalt is generally prepared by mixing aggregate and filler materials with a bitumen-based binder. Bitumen is derived from the heaviest portion from the oil distillation process. It may have different properties due to the different origins of the oil as well as due to the different distillation processes employed. Bitumen can be characterized by the presence of four classes of substances each having different molecular weight ranges: saturates, aromatics, resins, and asphaltenes.

Since bitumen is obtained from fossil sources that are non-renewable, there is a desire to at least partly replace it by renewable and sustainable bio-based alternatives.

Therefore, bio-based alternatives for bitumen are widely sought after for the manufacturing of asphalt and bitumen emulsions. As reported by some earlier patent literature e.g. EP2918640A1 and WO2019/092278, lignins have been identified as suitable additives and replacements for the conventional bitumen and polymeric bitumen in asphalt.

However, handling of lignin with a low moisture content of 0-20% (on weight basis) presents several issues. Among those is that the lignin during handling forms dust clouds. These dust clouds may further lead to dust explosions when sufficiently high concentration of combustible material is suspended in air.

Thus, there is a need for an agglomerated lignin (or lignin containing material) with a sufficiently large particle size to enable safer transportation and handling in the asphalt and bitumen emulsion manufacturing. In addition, there is a need for a process in which lignin is well dispersed and homogenously distributed over the entire matrix.

### SUMMARY OF THE INVENTION

The present invention provides a solution several of the problems of the prior art. A particular advantage of the process according to the present invention is that the dust forming fines are reduced to such extent that the risk of dust explosion is significantly reduced. The present invention also provides an improved binder composition in which lignin is well dispersed and homogenously distributed.

Thus, the present invention is directed to a process for preparing a binder for an asphalt composition or an asphalt composition, comprising the steps of
providing lignin, wherein the lignin is agglomerated and has a particle size distribution such that at least 80 wt-% of the agglomerates have a diameter within the range of from 0.1 mm to 5.0 mm;
disintegrating the agglomerated lignin to a particle size distribution such that at least 80 wt-% of the disintegrated particles have a diameter within the range of from 0.001 mm to 1.0 mm; and
mixing the disintegrated lignin with a bitumen blend to obtain a binder for an asphalt composition or mixing the disintegrated lignin with an asphalt blend to obtain an asphalt composition.

More specifically, the present invention is directed to a process for preparing preparing a binder for an asphalt composition or an asphalt composition, comprising the steps of
a) compaction of lignin, wherein lignin having a moisture content of from 1 wt-% to 45 wt-% is agglomerated by means of roll compaction, wherein the rolls have cavities and wherein the depth of each cavity used in the roll compaction is from 0.1 mm to 10 mm;
b) subjecting the compacted lignin from step a) to a milling step; followed by
c) a sieving step, wherein the product of step b) is subjected to sieving to remove particles having a particle diameter below 100 μm, to produce a final agglomerated lignin with a controlled particle size distribution in which the particle size distribution is governed by the porosity of the sieving screens used in the sieving step; and wherein less than 10 wt-% of the particles retained after step c) have a particle diameter below 100 μm;
d) disintegrating the product of step c) to a particle size distribution such that at least 80 wt-% of the disintegrated particles have a diameter within the range of from 0.001 mm to 1.0 mm;
e) mixing the disintegrated material of step d) with a bitumen blend to obtain a binder for an asphalt composition or with an asphalt blend to obtain an asphalt composition.

The present invention is also directed to a binder for an asphalt composition prepared using the process according to the present invention. The present invention is also directed to an asphalt composition prepared using the binder according to the present invention.

### BRIEF DESCRIPTION OF THE FIGURES

FIG. 1: illustrates particle size distribution of agglomerated and disintegrated lignin, compared to lignin in powder form.

### DETAILED DESCRIPTION

It is intended throughout the present description that the expression “lignin” embraces any kind of lignin, e.g. lignin originated from hardwood, softwood or annual plants. Preferably the lignin is an alkaline lignin generated in e.g. the Kraft process. Preferably, the lignin has been purified or isolated before being used in the process according to the present invention. The lignin may be isolated from black liquor and optionally be further purified before being used in the process according to the present invention. The purification is typically such that the purity of the lignin is at least 90%, preferably at least 95%, more preferably at least 98%, most preferably at least 99%, 99.5% or 99.9%. Thus, the lignin used according to the process of the present invention preferably contains less than 10%, preferably less than 5%, more preferably less than 2% impurities. The lignin may then be separated from the black liquor by using the process disclosed in WO2006031175.

It is particularly beneficial to carry out the compaction in step a) on a material that is essentially only lignin, i.e. in the absence of additives, since that makes the use of the compacted product easier, due to the absence of binders or other components that could otherwise negatively influence the application in which the compacted, milled and sieved lignin is supposed to be used.

Preferably, the lignin is dried before compaction, i.e. before step a) of the process according to the present invention. The drying of the lignin is carried out by methods and equipment known in the art. The lignin used in step a) has a moisture content of from 1 wt-% to 45 wt-%. Preferably, the moisture content of the lignin before compaction according to the present invention is less than 25 wt-%, preferably less than 10 wt-%, more preferably less than 8 wt-%.

The lignin powder obtained after drying has a wide particle size distribution ranging from 1 μm to 2 mm which is significantly skewed towards the micrometer range, meaning that a significant proportion of the particles has a diameter in the range of 1 to 200 micrometers. It is known in the art that there is a strong correlation between explosivity characteristics and particle size distribution exists (BIA-Report 13/97 Combustion and explosion characteristics of dusts), that is, the smaller the particles, the more severe is the risk of explosion. The particles below a diameter of 100 micrometers are here considered as fines.

The roll compaction of lignin can be achieved by a roller compactor to agglomerate the lignin particles. The agglomeration according to the present invention is a process comprising three steps: compaction (a), milling (b) and sieving (c).

In the compaction step a), a first intermediate product is generated. Here, the fine lignin powder is compacted into flakes by compaction rollers Equipment suitable for carrying out the compaction are known in the art.

Preferably, the lignin used in step a) is provided in the form of a powder having a particle size distribution such that at least 25 wt-% of the lignin has a particle diameter of from 1 μm to 100 μm.

In the milling step b) of the process, the first intermediate product from the compaction step is subjecting to milling or grinding, such as by means of rotary granulator, cage mill, beater mill, hammer mill or crusher mill and or combinations thereof. During this step, a secondary intermediate product is generated.

In the sieving step c) of the process, the secondary intermediate product from the milling step b) is screened by means of physical fractionation such as sieving, also referred to as screening, to obtain a final product which is agglomerated lignin with a defined particle size distribution set by the porosity of the sieves or screens in this step. By using a screening stage with two or more different screen porosities, several fractions with more defined particle size distribution are obtained.

The lignin obtained in step c) preferably has a particle size distribution such that at least 80 wt-% of the agglomerates have a diameter within the range of from 0.1 mm to 5.0 mm, more preferably at least 80 wt-% of the agglomerates have a diameter within the range of from 0.1 mm to 2.0 mm.

In step d), the product of step c) is disintegrated to obtain a particle size distribution such that at least 80 wt-% of the disintegrated lignin particles have a diameter within the range of from 0.001 mm to 1.0 mm. The disintegration can be carried out using methods and equipment known in the art, such as by crushing or milling.

Preferably, the disintegration is carried out such that at least 50 wt % of the disintegrated lignin particles have a diameter in the range of from 1 μm to 500 μm.

In one embodiment of the present invention, the disintegration is carried out at an asphalt plant. Thus, lignin can be transported to the asphalt plant in the form of agglomerated lignin, having a particle size distribution such that at least 80 wt-% of the agglomerates have a diameter within the range of from 0.1 mm to 5.0 mm. The agglomerated lignin is then subjected to disintegration, preferably at the same location at which the lignin is mixed with the bitumen blend or asphalt blend. A particular advantage is that the handling of the lignin is significantly simplified when the lignin is transported in the agglomerated form.

The bitumen blend used according to the present invention comprises bitumen and optionally for example vegetable oil.

The bitumen used in the bitumen blend, with which the disintegrated lignin is mixed, is derived from the heaviest portion from the oil distillation process. It may have different properties due to the different origins of the oil as well as due to the different distillation processes employed. However, bitumen can be characterized by the presence of four classes of substances each having different molecular weight ranges: saturates, aromatics, resins, and asphaltenes. The bitumen in the bitumen blend used according to the present invention may be selected from virgin bitumen, recycled bitumen, or mixtures thereof. In the bitumen blend, the bitumen may be present in an amount of at least 1, 10, 15, 20, 25, 30, 40, 50, 60, 70, 80, 90, 100 wt. % and/or at most 300, 250, 200, 180, 150, 125, 110 wt. %, preferably 80-120 wt. % with respect to the weight of the disintegrated lignin. The lignin preferably replaces 40-60 wt-% of the bitumen.

The bitumen blend may also comprise other components. For example, the bitumen blend may comprise vegetable oil, or non-fossil derived oil, preferably chosen from linseed oil, soybean oil, sunflower oil, and safflower oil. Preferably, the vegetable oil has a dynamic viscosity of 0.01-1600 Pas at 20° C. or 0.01-1000, 0.03-500, or 0.05-250, preferably 0.1-100, 0.2-50, 0.3-20, 0.4-10, 0.5-5 or 0.5-2 Pa·s at 20° C. Kinematic viscosity may be determined by using an Ubbelohde viscometer according to ASTM D 445 or its equivalent BS 188. The dynamic viscosity can be calculated from the kinematic viscosity data by multiplying the latter by the density.

As used herein, the term “asphalt blend” refers to a blend comprising aggregates and optionally a binder, such as bitumen. The asphalt may be or comprise reclaimed asphalt pavement.

As used herein, the term “asphalt composition” refers to the composition obtained by the method according to the present invention.

To obtain an asphalt composition, the binder is mixed with aggregates, such as sand, stone and/or rubble. Typically, the asphalt composition comprises about 60-90 wt-% aggregates. According to the present invention, the amount of lignin in the asphalt composition is preferably in the range of from 1 wt-% to 12 wt-%, preferably from 2 wt-% to 7 wt-%.

The lignin can be mixed with the bitumen blend and the mixture of lignin and the bitumen blend is then mixed with the aggregates. Alternatively, the bitumen blend may first be mixed with the aggregates and the lignin can then be added to the mixture of the bitumen blend and the aggregates. Alternatively, the lignin can be added to the aggregates in the asphalt blending step prior the dosing of bitumen. In this embodiment, the lignin is preferably added to the aggregates in its agglomerated form, i.e, wherein the lignin is agglomerated and has a particle size distribution such that at least 80 wt-% of the agglomerates have a diameter within the range of from 0.2 mm to 5.0 mm. The disintegration of the lignin agglomerates to obtain a particle size distribution such that at least 80 wt-% of the disintegrated particles have a diameter within the range of from 0.001 mm to 1.0 mm preferably takes place during mixing with the aggregates, wherein the aggregates may also comprise fibers and/or other fillers. During the mixing, the agglomerated lignin becomes disintegrated. A particular benefit of this embodiment is that a separate disintegration step wherein the lignin agglomerates are disintegrated can be avoided and the process for preparing the asphalt composition can be simplified, still achieving the benefit of reducing the amount of dust forming fines and still obtaining an improved binder composition in which lignin is well dispersed and homogenously distributed. Alternatively, the lignin can be added to reclaimed asphalt pavement prior to it being mixed with asphalt blend.

The asphalt composition can be used for example as a pavement or road paving.

The present inventors surprisingly found that agglomerated and disintegrated lignin has a particle size distribution which is different from lignin in powder form obtained from for example the kraft process. It has been found that the agglomerated and disintegrated lignin has a certain fraction of relatively small particles and a certain fraction of relatively large particles. Without being bound by theory, the characteristic size distribution facilitates obtaining a homogenous distribution of lignin throughout the matrix, since the small particles, which dissolve or disperse quickly, assist in dissolving or dispersing the large particles. Advantageously, the agglomerated and disintegrated lignin has a particle size distribution such that the proportion of particles smaller than 40 μm, which are easily airborne and therefore do not participate in the mixing with the bitumen blend or asphalt blend, is significantly lower than in lignin in powder form obtained from for example the kraft process.

### EXAMPLES

### Example 1—Particle Size Distribution

Agglomerated and disintegrated lignin was prepared by roll compaction, followed by milling, sieving and disintegration.

A sample of dried lignin powder produced in the kraft process was obtained.

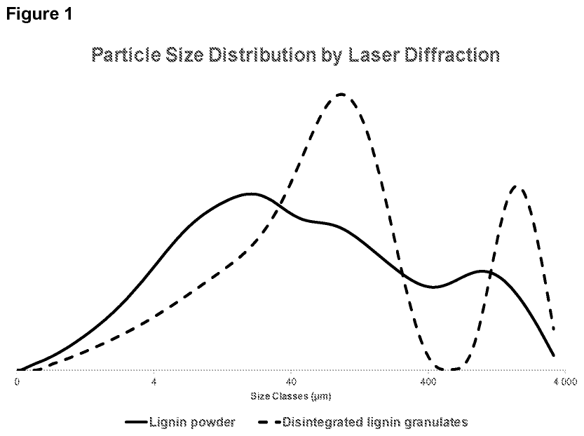

Powders of the dried lignin and disintegrated lignin granules (agglomerates) were subjected to particle size distribution by means of laser diffraction as described in ISO 13320:2020. Data is reported as volume-based distribution and illustrated in FIG. 1.

In view of the above detailed description of the present invention, other modifications and variations will become apparent to those skilled in the art. However, it should be apparent that such other modifications and variations may be effected without departing from the spirit and scope of the invention.

1. A process for preparing a binder for an asphalt composition or an asphalt composition, comprising the steps of
providing agglomerated lignin, wherein the agglomerated lignin has a particle size distribution such that at least 80 wt-% of agglomerated lignin have a diameter within a range of from 0.2 mm to 5.0 mm;
disintegrating the agglomerated lignin to form disintegrated lignin particles having a particle size distribution such that at least 80 wt-% of the disintegrated lignin particles have a diameter within a range of from 0.001 mm to 1.0 mm; and
mixing the disintegrated lignin particles with a bitumen blend to obtain a binder for an asphalt composition or mixing the disintegrated lignin particles with an asphalt blend to obtain an asphalt composition.

2. The process according to claim 1, comprising the steps of
a) compaction lignin, wherein lignin having a moisture content of from 1 wt-% to 45 wt-% is agglomerated by means of roll compaction with one or more rolls, wherein the one or more rolls have cavities and wherein a depth of each cavity used in the roll compaction is from 0.1 mm to 10 mm;
b) subjecting the compacted lignin from step a) to a milling step; followed by
c) a sieving step to remove particles having a particle diameter below 100 μm and provide a final agglomerated lignin with a controlled particle size distribution in which a particle size distribution is governed by a porosity of the sieving screens used in the sieving step; and wherein less than 10 wt-% of particles retained after step c) have a particle diameter below 100 μm, and wherein the particles retained after step c) comprise the agglomerated lignin.

3. The process according to claim 2, wherein the lignin is agglomerated without addition of any additives.

4. The process according to claim 2, wherein the lignin of step a) has a moisture content of from 5 wt-% to 10 wt-%.

5. The process according to claim 2, wherein a purity of the lignin of step a) is at least 95%.

6. A binder for an asphalt composition produced by the process according to claim 1.

7. An asphalt composition produced by the process according to claim 1.

8. A pavement or road paving comprising:
the asphalt composition according to claim 7.

9. The process according to claim 1, wherein the step of disintegrating the agglomerated lignin comprises mixing the agglomerated lignin with aggregates before an addition of the bitumen blend.

10. The process according to claim 9, wherein the aggregates comprise sand, stone, rubble, or combinations thereof.
